(19) United States
(12) Patent Application Publication
(10) Pub. No.: US 2004/0193693 A1
(43) Pub. Date: Sep. 30, 2004

(54) Data processing apparatus and method fo operating a data processing apparatus

(76) Inventors: Om Prakash Gangwal, Eindhoven (NL); Pieter Van Der Wolf, Eindhoven (NL); Andre Krijn Nieuwland, Eindhoven (NL); Gerben Essink, Eindhoven (NL)

Correspondence Address: Philips Electronics North America Corporation, Intellectual Property & Standards, MS41 SJ, 1109 McKay Drive, San Jose, CA, 95131, US

(21) Appl. No.: 10/481,983

(22) PCT Filed: Jun. 20, 2002
(86) PCT No.: PCT/IB02/02340

(30) Foreign Application Priority Data
Jun. 29, 2001 (EP) 01202517.7

(51) Int. Cl. G06F 15/167

(52) U.S. Cl. 709/213

(57) ABSTRACT

A data processing apparatus according to the invention comprises at least a first (1.2) and a second processor (1.3), which processors are capable of communicating data to each other by exchanging tokens via a buffer according to a synchronization protocol. The protocol maintains synchronization information comprising at least a first and a second synchronization counter (writec, readc), which are readable by both processors. At least the first processor (1.2) is capable of modifying the first counter (writec), and at least the second processor (1.3) is capable of modifying the second counter (readc). The protocol comprises at least a first command (claim) which when issued by a processor results in a verification whether a requested number of tokens is available to said processor, and a second command (release) which results in updating one of the synchronization counters to indicate that tokens are released for use by the other processor. At least one of the processors (1.3) comprises a storage facility for locally storing an indication (Nc; writec′, readc) of the amount of tokens available to that processor, wherein issuing the first command (claim) results in a verification of the number of tokens available to said processor on the basis of said indication. A negative outcome of the verification results in updating of this indication on the basis of at least one of the synchronization counters. Issuing the second command (release) by a processor results in updating the indication in accordance with the number of tokens released to the other processor.

The invention relates to a data processing apparatus.

The invention further relates to a method for operating a data processing apparatus.

Signal-processing functions determine the performance requirements for many products based on standards like MPEG-x, DVB, DAB, and UMTS. This calls for efficient implementations of the signal processing components of these products. However, because of evolving standards and changing market requirements, the implementation requires flexibility and scalability as well. A macropipeline setup is a natural way to model these applications, since streams of data are processed; in this setup the functions (tasks) are the stages and there are buffers between the stages to form the pipeline. This is a way to exploit task-level parallelism (TLP), because all stages can operate in parallel.

A multiprocessor system comprising a plurality of processors is very suitable for implementation of such a macropipeline. A multiprocessor system may comprise several types of processors, such as programmable processors, e.g. RISC-processors or VLIW processors, or dedicated hardware. One processor may execute a particular task, or more than one task in a time-shared fashion.

In order to exchange data between processors which execute tasks in subsequent stages of the macropipeline, usually a producing processor writes its data to a buffer in a shared memory and the consuming processor reads this data from the buffer. A synchronization protocol prevents that the consuming processor attempts to read tokens in the buffer which have not been written by the producing processor yet likewise it prevents that the producing processor overwrites tokens which have no been read by the consuming processor yet.

In a known synchronization protocol the number of tokens available to the producing processor (producer) is maintained in a first counter and the number of tokens available to the consuming processor (consumer) is maintained in a second counter. Each time that the producer releases a token, i.e. makes it available to the consumer it increases the second counter and decreases the first counter. By reading the first counter it verifies whether it has tokens available. A disadvantage of the known synchronization protocol is that since each of the counters has to be accessible by both processors a kind of arbitration mechanism is necessary to manage access of the processors to the counters. This will delay operation of the processors, and therewith the efficiency of the data processing apparatus.

It is a purpose of the invention to provide a data processing apparatus having an improved efficiency. It is a further object of the invention to provide a method for operating a data processing apparatus with an improved efficiency.

In accordance to achieve this purpose the data processing apparatus according to the invention is defined by claim 1.

In the data processing apparatus according to the invention at least one of the processors comprises a storage facility for locally storing an indication of the amount of tokens available to that processor. Instead of determining the amount of available tokens on the basis of the synchronization information which is shared by the two processors the processor verifies the number of tokens which it has available on the basis of said locally stored indication. In this way it can proceed significantly faster provided that the locally stored indication indicates that tokens are available. If this is not the case the indication is updated on the basis of at least one of the synchronization counters. In order to prevent that the processor would attempt to use the same buffer space again it updates the locally stored indication when it releases one or more tokens to the other processor with which it is communicating. Note that the locally stored indication is a pessimistic indication of the actually available number of tokens. Once the processor or a separate communication shell attached thereto has updated its locally stored indication, the value of this indication is equal to the actual number of tokens. But if the processor releases tokens it decreases the locally stored indication in conformance therewith. Therefore the value of the locally stored indication will at most equal to the actual value, so that it will not occur that tokens are read before they are written, or are overwritten before they are read.

The first command for claiming a number of tokens may be implemented in software e.g. by a function claim having as parameters the number of tokens and a channel. The function claim may in response return the first token becoming available. Separate functions may be defined for a claim for tokens to be written, i.e. an output channel and a claim for tokens to be read, i.e. an input channel. A processor can have more than one input channels because it may execute several tasks in a time shared way, each task having its own input channel. For the same reason it may have more than one output channel.

The second command for releasing tokens may be implemented by a function call release having as parameters the identification of the channel and the amount of tokens which is released. Separate function calls for releasing written tokens and read tokens may be specified.

Instead of implementing these commands in software a implementation in dedicated hardware is possible as well.

It is noted that U.S. Pat. No. 6,173,307 B1 discloses a multiprocessor system comprising circular queue shared by multiple producers and multiple consumers. Any producer or consumer can be permitted to preempt any producer or consumer at any time without interfering with the correctness of the queue.

It is further noted that U.S. Pat. No. 4,916,658 describes an apparatus comprising a dynamically controlled buffer. The buffer is suitable for storing data words consisting of several storage locations together with circuitry providing a first indicator that designates the next storage location to be stored into, a second indicator designating the next storage location to be retrieved from, and circuitry that provides the number of locations available for storage and the number of locations available for retrieval.

Claim 2 claims a practical embodiment. When verifying the number of tokens available the processor will detect that the locally stored indication indicates that no tokens are available. As a result it will update this indication so that comprises the correct value.

In the embodiment of claim 3 the processor does not wait until the locally stored value does indicate that no tokens are available, e.g. by having the value 0, but prefetches the actual value at a suitable moment, e.g. when it detects that the communication network has a low activity, or upon initialization of the data processor.

Several synchronization protocols are possible, a first of which is claimed in claim 4, and a second being claimed in claim 5.

In the embodiment of claim 6 the data produced by a producer is read by more than one consumer.

Depending on the application at least one of the processors is a general purpose processor or an application specific programmable device executing a computer program. Alternatively, or in combination dedicated processors may be used.

A shell coupled to a processor facilitates multitasking, in that it may reduce the number of interrupts which has to be handled by the processor itself. This reduces the number of times that an idle processor has to be activated unnecessarily, or that a processor has to interrupt an other task which it is processing. In this way the efficiency of the processor is improved.

Several options are possible to implement such a shell for selecting interrupt signals depending on the type of interrupt signals and how they are encoded. In an embodiment the interrupt signals are indicative for a data channel of the processor. A practical way to implement this is by assigning bits in a register to respective input channels of the processor. For example a 32 bit register could support 32 input channels, wherein for example channel 0 is assigned bit 0, channe 1 is assigned bit 1 of the register etc. When an other processor sents an interrupt signal destinated for channel k of the processor the corresponding bit k of the signal register is set. The shell of the receiving processor can select specific interrupt signals by means of a mask register, wherein each bit represents for a particular channel whether the processor wants to ignore the interrupt or not. E.g. if the bit corresponding to channel two is masked, this signal will not cause an interrupt in the processor, and no wake up will happen. In this example, the processor could be busy with processing, in which all bits will be masked, or the processor/task could be waiting for a full/empty token on channel 1, in which case it is not interested on what happens on channel 2.

The signal and the mask register could have an arbitrary number of bits depending on the number of channel which should be supported. Alternatively it is possible to support each channel by a number and use a list or look-up table to determine whether the processor should be interrupted for that channel or not. This is however a more complex solution.

Instead of identifying a interrupt signal by its channel number it could be identified by a task number instead. In this embodiment all channels with signals for a specific task set the same bit in the signal register of the shell. In this way, a number of tasks equal to the number of bits in the signal register could be uniquely addressed, whereas each task may have more than one channel. The waiting is a little less specific than with unique channel identification, but the number of unnecessary wake-ups is still small and more channels can be supported with limited hardware.

Of course, the taks numbers do not have to be identical to the bit numbers, (it is just simple to do it that way) as long as the relation is defined. Furthermore, it also possible that (groups of) tasks share the same signal-interrupt-number.

Instead of identifying the task carried out by the receiver, the senders task identification number could be signalled. In that case the receiving processor can select interrupt signals from a specific task instead of for a specific task. It may depend of the number of external tasks and the number of tasks on the processor personal preference or what seems the most usefull/efficient.

These and other aspects are described in more detail with reference to the drawing. Therein

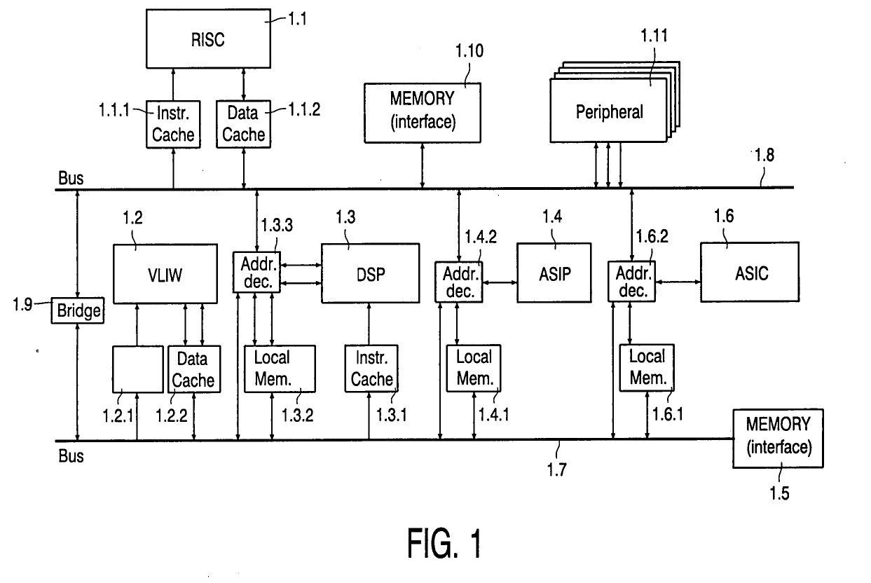

FIG. 1 schematically shows a data processing apparatus according to the invention,

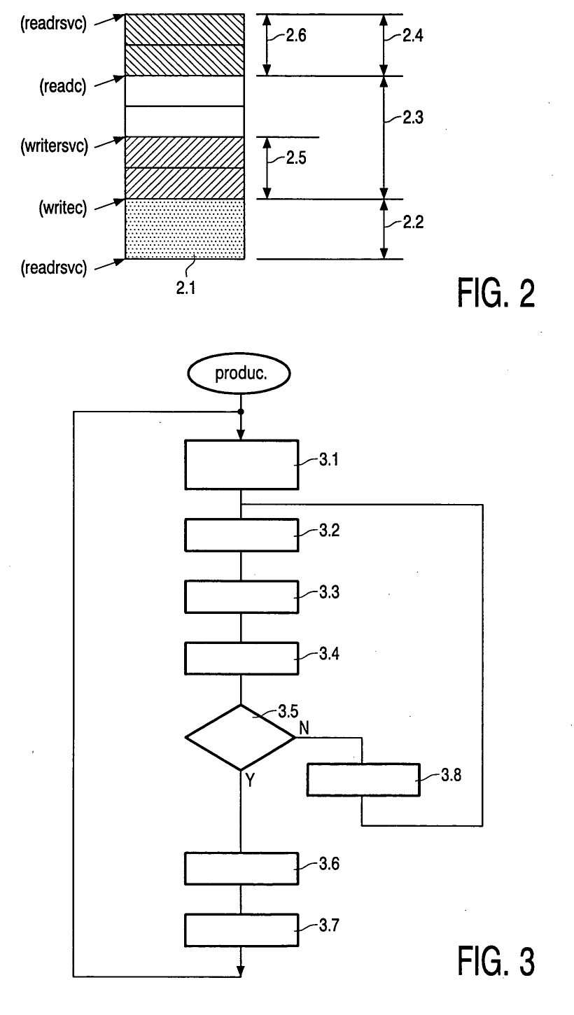

FIG. 2 schematically shows a way in which synchronization counters indicate partitions of a buffer,

FIG. 3 illustrates a first aspect of a synchronization method according to the invention,

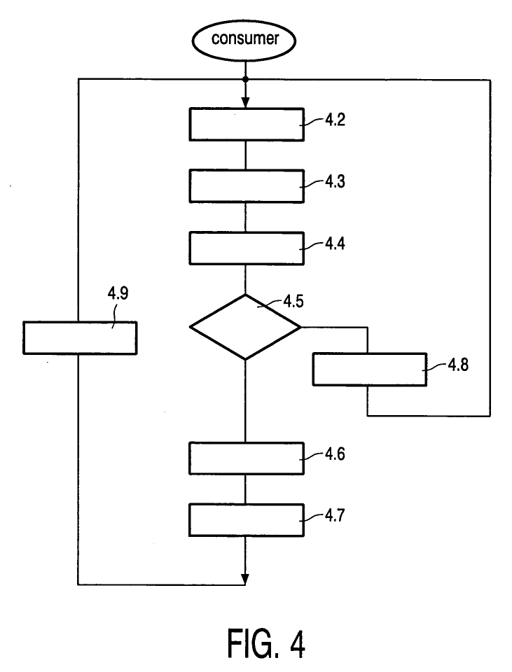

FIG. 4 illustrates a second aspect of a synchronization method according to the invention,

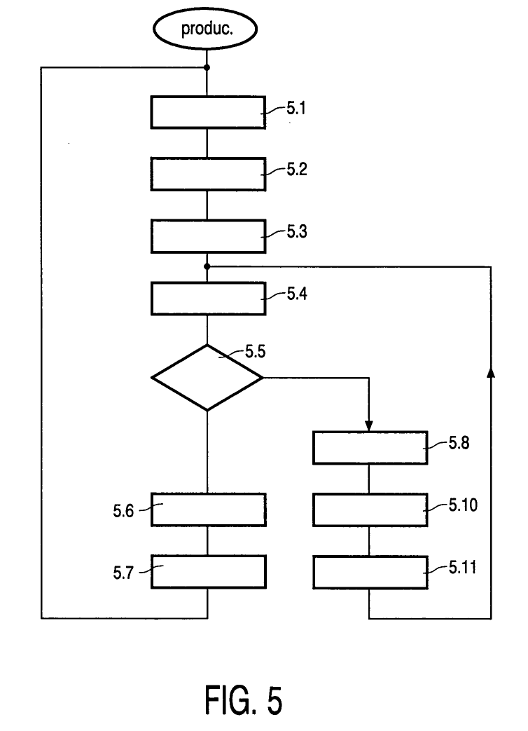

FIG. 5 illustrates a further synchronization method according to the invention,

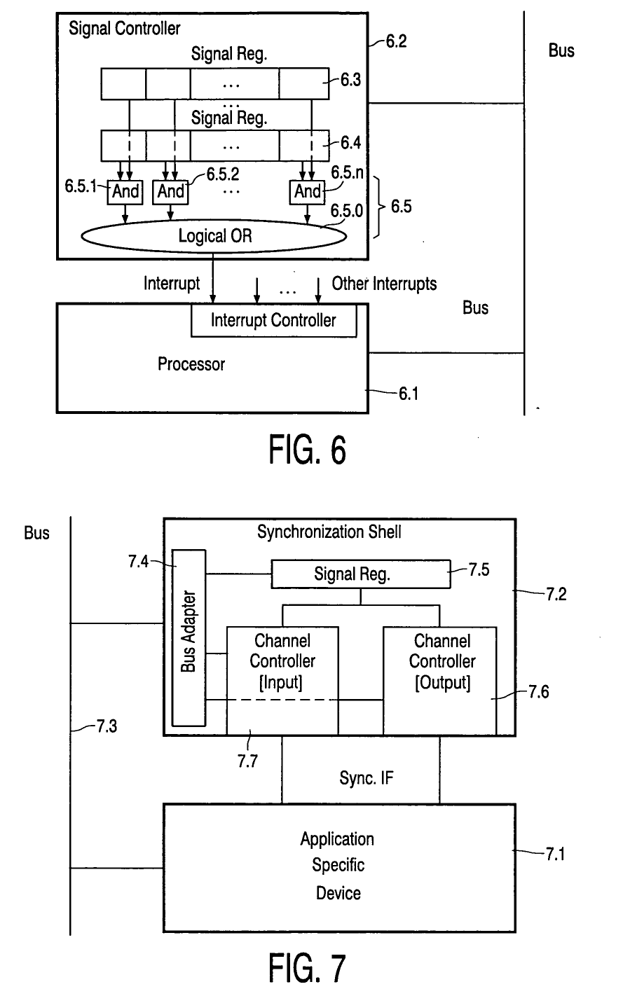

FIG. 6 illustrates in more detail a signal controller for a processor,

FIG. 7 illustrates a synchronization shell for a processor, and

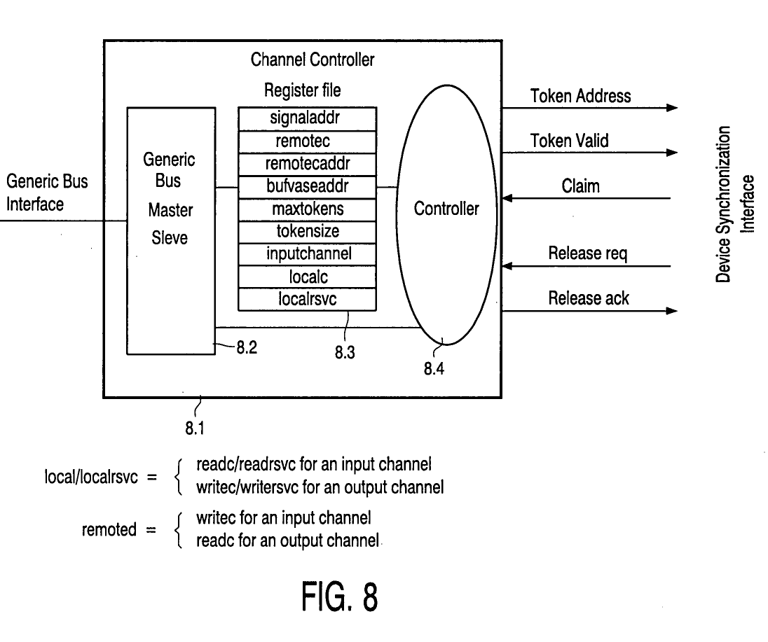

FIG. 8 illustrates a channel controller.

FIG. 1 shows a data processing apparatus comprising at least a first 1.2 and a second processing means 1.3. The first processing means, a VLIW processor 1.2 is capable of providing data by making tokens available in a buffer means, located in memory 1.5. The tokens are readable by the second processing means 1.3, a digital signal processor, for further processing. The data processing apparatus further comprises a RISC processor 1.1, an ASIP 1.4, and a dedicated hardware unit 1.6. The VLIW processor 1.2, the DSP 1.3, the ASIP 1.4, the memory 1.5 and the ASIC 1.6 are mutually coupled via a first bus 1.7. The RISC processor 1.1 is coupled to a second bus 1.8 which is coupled on its turn to the first bus 1.7 via a bridge 1.9. A further memory 1.10 and peripherals 1.11 are connected to the second bus 1.8. The processors may have auxiliary units. For example the RISC-processor 1.1 comprises an instruction cache 1.1.1 and data cache 1.1.2. Likewise the VLIW processor has an instruction cache 1.2.1 and data cache 1.2.2. The DSP 1.3 comprises an instruction cache 1.3.1, a local memory 1.3.2, and an address decoder 1.3.3. The ASIP 1.4 comprises a local memory 1.4.1 and address decoder 1.4.2. The ASIC 1.6 comprises a local memory 1.6.1 and address decoder 1.6.2. The processing means 1.2, 1.3 are each assigned a respective synchronization indicator. Both synchronization indicators are accessible by both the first 1.2 and the second processing means 1.3. The first synchronization indicator is at least modifiable by the first processing means 1.2 and readable by the second processing means 1.3. The second synchronization indicator is at least modifiable by the second processing means 1.3, and readable by the first processing means 1.2.

Each of the synchronization indicators is represented by a counter. The counter which represents the first synchronization indicator (p-counter) is indicative for a number of tokens being written by the first processing means 1.2. The counter which represents the second synchronization indicator (c-counter) is indicative for a number of tokens being read by the second processing means 1.3. Several options are possible for the skilled person to indicate the number of tokens by a counter as long as a comparison of the counter values makes it possible to calculate the number of tokens which are available to each of the processors. For example the counter value could be equal to the number of tokens mod n, wherein n is an integer value. Otherwise each step of the counter could represent a fixed number of tokens, or a token could be represented by a number of steps of the counter value.

In a practical embodiment the counters are a pointer to the address up to which the buffer means is made available to the other processor. This is schematically illustrated in FIG. 2. This Figure schematically shows a buffer space 2.1 within the memory 1.5 which is used by the first processing means 1.2 for providing data to the second processing means 1.3. The buffer space 2.1 is arranged as a cyclical buffer. The buffer space 2.1 comprises a first zone 2.2 and a second zone 2.4 which contains data written by the first processing means 1.2, which is now available to the second processing means 1.3. The buffer space 2.1 further comprises a third zone 2.3 which is available to the first processing means 1.2 to write new data. The p-counter writec indicates the end of the first zone 2.2, and the c-counter readc points to the end of the second zone 2.3.

A portion 2.6 within the first zone 2.2 and the second zone 2.4 is reserved by the reservation counter readrsvc in combination with the synchronization counter readc.

A portion 2.5 within the third zone 2.3 is reserved by the reservation counter writersvc in combination with the synchronization counter writec.

A subtraction of the two counters modulo the buffer size buffsz gives the number of valid tokens Nc available to the second processing means 1.3 and the number of empty tokens Np which are available to be filled by the first processing means 1.2.

Nc=(writec−readc) mod buffsz, and (1)

Np=(readc−writec) mod buffsz. (2)

The p-counter and the c-counter are stored in a location which is accessible to at least two processing means. Each access to these counters causes a delay, as some arbitration mechanism is required which gives access to said location. In order to further improve the efficiency the processing means are provided with a register means for locally storing an indication of the amount of tokens available. In an embodiment the first processing means 1.2 have a register for storing a counter value readc′, and the second processing means 1.3 have a register for storing a counter value writec′. The value writec is already available to the first processing means 1.2 as these means determine the progress of the p-counter. For analogous reasons the value readc is available to the second processing means. Instead of calculating the number Nc of actually available valid tokens the second processing means 1.3 now calculates a pessimistic estimation Nc′ of this value according to:

Nc′=(writec′−readc) mod buffsz. (3)

As the values writec′ and readc together are indicative, i.e. a pessimistic estimation, for the number of tokens Nc available to be read, the facilities for locally storing these variables form register means for locally storing an indication of the amount of tokens available to be read. Alternatively the value Nc′ may be stored locally instead of the value writec′. Likewise the first processing means 1.2 now calculates a pessimistic estimation Np′ of the actually available number of empty tokens according to:

Np′=(readc′−writec) mod buffsz. (4)

The facilities for locally storing these variables form register means for locally storing an indication of the amount of tokens available to be written.

Alternatively the value Np′ may be stored locally instead of the value readc′.

At the moment that the first processing means 1.2 detect that Np′ has a value 0, it is necessary to update the value readc′ in the local register of the first processing means with the momentary value readc of the c-counter. At the moment that the second processing means 1.3 detect that Nc′ has a value 0, it is necessary to update the value writec′ in the local register of the second processing means with the momentary value writec of the p-counter.

The data relating to the communication channel between the first 1.2 and the second processing means 1.3 may be organized in a shared data structure in addition to the information stored locally. An example of such a datastructure CHP_channelT as specified in the c-language is as follows:

```
typedef struct {
  int id;
  int buffsz;
  int flags;
  struct CHP_taskS* ptask;
  struct CHP_taskS* ctask;
  union {
    CHP_bufferT* buffer_pointers;
    struct {
      int token_size;
      CHP_bufferT buffer;
    } buffer_data;
    } channel;
unsigned writec;
unsigned readc;
CHP_channel_hwT* pchan;
CHP_channel_hwT* cchan;
} CHP_channelT;
```

Apart from the counter values writec and readc this data structure comprises the following data.

id is a value identifying the channel, so as to enable a processing scheme including a plurality of channels, for example a first channel for transferring data from a first processing means to a second processing means, a second channel for transferring data from the second processing means to the first processing means and a third channel for transferring data from the second processing means to a third processing means.

The value buffsz indicates the size of the buffer, i.e. as the number of tokens which can be stored in the buffer.

The value flags indicates properties of the channel, e.g. if the synchronization is polling or interrupt based, and whether the channel buffers are allocated directly or indirectly. As an alternative it can be decided to give the channel predetermined properties, e.g. restrict the implementation to interrupt based synchronization with directly allocated buffers. In that case the value flags may be omitted.

ptask and ctask are pointers to the structure describing the task of the first processing means, the producer, and the task of the second processing means, the consumer.

The task structure may contain for example

an identifier for the task (whose task structure is it)

a function pointer (if it is a task on the embedded processor; then after booting the root_task can jump to this friction and start the application. Void otherwise.

a device type: to indicate on what type of device the task should be running.

This is useful for the boot process: a task running as a Unix process has to be initialized in a different way than a task running on a DSP or on a Embedded processor or on dedicated hardware. By having a major device type, it is easy to select the proper boot procedure.

a device number: This enable to distinguish between e.g. the first Unix co-processor from the second. this can be done by giving them a unique number.

the number of channels

a list of pointers to channel datastructures.

In this way, when e.g. a UNIX task is started, it can first read its task structure, and then read all the information about all the channels connected to that task. This makes the booting process a lot easier, and avoids that very time some task is added, a control process has to be modified to have all tasks load the proper data structures.

The union channel indicates the location of the buffer. Either the buffer is located indirectly via a pointer buffer pointers to the structure CHP_bufferT, or the buffer is included in the structure CHP_channelT.

The integer token_size indicates the size of the tokens which are exchanged by the producer and the consumer, e.g. in the number of bytes.

As described above it is favorable if the processing means comprise local data such as the counter value writec′ for the consuming task. Preferably the data structure CHP_channelT comprises references pchan, cchan to a datastructure comprising the local task information.

Such a datastructure may have the following form specified in the language c:

typedef struct {

unsigned sgnl_reg_addr;

unsigned sgnl_value;

unsigned rsmpr_addr;

int buffsz;

CHP_bufferT_buf ptr;

unsigned lsmpr_reg;

int in_out;

int token_size;

} CHP_channel_hwT;

The structure comprises an unsigned integer sgnl_reg_addr indicating the signal register address of other device with which the processing means is communicating. An interrupting processor may leave in the signal register of a device an indication of the task or of the channel for which the interrupt took place.

It further comprises unsigned integer sgnl_value indicating its own signaling value.

The unsigned value rsmpr_addr indicates the remote synchronization counter address in the other device.

As described above, the buffer size buffsz is used by the producer to calculate the number of empty tokens available, and by the consumer to calculate the number of written tokens available.

The value buf_ptr indicates the base address of the buffer.

The unsigned integer lsmpr_reg stores the value of the local channel synchronization counter.

The type of channel input/output is determined from the integer in_out.

The integer token_size indicates the size of the tokens which is exchanged via the channel.

FIG. 3 illustrates a first aspect of a method according to the invention of synchronizing a first and a second processing means in a data processing apparatus.

In step 3.1 the first processing means 1.2 generates one or more tokens,

In step 3.2 the first processing means reads the first counter writec which is indicative for a number of tokens made available to the second processing means.

In step 3.3 the first processing means 1.2 read the second counter readc which is indicative for the number of tokens consumed by the second processing means 1.3.

In step 3.4 the first processing means compares these counters by means of the calculation of equation 2.

In step 3.5 the first processing means 1.2 decide in dependence of this comparison either to carry out steps 3.6 and 3.7, if the value of Np is greater or equal than the number of tokens generated, or to carry out step 3.8 in the other case.

In step 3.6 the first processing means 1.2 writes the tokens to the buffer means 2.1 and subsequently modifies the first counter writec in step 3.7, after which it continues with step 3.1.

In step 3.8 the first processing means wait, e.g. for a predetermined time interval, or until it is interrupted and repeats steps 3.2 to 3.5.

The second processing means 1.3 carries out an analogous procedure, as illustrated in FIG. 4.

In step 4.2 the second processing means 1.3 reads the first counter writec which is indicative for a number of tokens made available to it by the first processing means 1.2.

In step 4.3 the second processing means 1.3 read the second counter readc which is indicative for the number of tokens it has consumed.

In step 4.4 the second processing means 1.3 compares these counters by means of the calculation of equation 1.

In step 4.5 the second processing means 1.3 decide in dependence of this comparison either to carry out steps 4.6 and 4.7, if the value of Nc is greater or equal than the number of tokens generated, or to carry out step 4.8 in the other case.

In step 4.6 the second processing means 1.3 reads the tokens from the buffer means and subsequently modifies the second counter in step 4.7. Before continuing with step 4.1 it may execute a data processing step 4.9.

In a preferred embodiment a processing means locally stores a copy of a value of the other processing means with which it is communicating.

FIG. 5 illustrates how this local copy is used in a preferred method according to the invention.

Steps 5.1 and 5.2 are analogous to steps 3.1 and 3.2 in FIG. 3.

However in step 5.3 instead of reading the value readc of c-counter, which is stored remotely, the first processing means 1.2 read a locally stored value readc′. This read operation usually takes significantly less time than reading the remote value readc.

Step 5.4 is analogous to step 3.4 in FIG. 3, apart from the fact that the first processing means 1.2 use this locally stored value to calculate Np′, as in equation 4.

In step 5.5 the first processing means 1.2 decide in dependence of this comparison either to carry out steps 5.6 and 5.7, if the value of Np is greater or equal than the number of tokens generated, or to carry out steps 5.8, 5.10 and 5.11 in the other case.

Steps 5.6 and 5.7 are analogous to steps 3.6 and 3.7 of FIG. 3.

In step 5.8 the first processing means may wait, e.g. for a predetermined time interval, or until it is interrupted. Subsequently it reads the remote value readc in step 5.10 and store this value locally as the variable readc′ in step 5.11. According to this method it is only necessary to read the remote value readc if the number of empty tokens calculated from the local stored value readc′ is less than the number of tokens which is to be written in the buffer. The value Np′ could be stored locally instead of the value of readc′. In this case the value Np′ should be updated after each write operation for example simultaneously with step 5.7.

Likewise it is possible to improve the efficiency of the second processing means, executing the consuming process, by using a locally stored value of prodc or Nc′.

Instead of using the synchronization counters writec and readc as described above, the data processing system according to the invention may use a first synchronization counter token1 indicative for an amount of tokens available to the first processor and the second synchronization counter token2 is indicative for an amount of tokens available to the second processor. Each time that the producer releases a token, i.e. makes it available to the consumer it increases the second counter and decreases the first counter. By reading the first counter it verifies whether it has tokens available. According to the invention one of the processors, for example the first, has a local indication. If the first processor detects that no tokens are available on the basis of said local indication it may simply copy the value of the first synchronization counter token1. Likewise the second processor may use the value of token2 to update its local indication if necessary.

In order to further reduce communication overload, the processing means 6.1 may be provided with a signal controller 6.2 as is schematically illustrated in FIG. 6. The signal controller comprises a signal register 6.3 and a mask register 6.4. The contents of the registers in the signal controller are compared to each other in a logic circuit 6.5 to determine whether the processor 6.1 should receive an interrupt. Another processor sending the processor a message that it updated a synchronization counter updates the signal register 6.5 so as to indicate for which task it updated this counter. For example, if each bit in the signal register represents a particular task, the message has the result that the bit for that particular task is set. On the other hand the processor 6.1 indicates in the mask register 6.4 for which tasks it should be interrupted. The logic circuit 6.5 then generates an interrupt signal each time that a message is received for one of the tasks selected by the processor 6.1. In the embodiment shown the logic circuit 6.5 comprises a set of AND-gates 6.5.1-6.5.n, each AND gate having a first input coupled to a respective bit of the signal register 6.3 and a second input coupled to a corresponding bit of the mask register 6.4. The logic circuit 6.5 further comprises an OR-gate 6.5.0. Each of the AND-gates has an output coupled to an input of the OR-gate. The output of the OR-gate 6.5.0 provides the interrupt signal.

FIG. 7 shows an embodiment wherein the processor 7.1 has a separate synchronization shell 7.2 for supporting communication with other processing means via a communication network, e.g. a bus 7.3. The synchronization shell 7.2 comprises a bus adapter 7.4, a signal register 7.5 for storing the identity of tasks for which the synchronization shell 7.2 has received a message. The synchronization shell 7.2 further comprises channel controllers 7.6, 7.7. These serve to convert commands of the processor 7.6 in signals to the bus 7.3. Usually an application specific device 7.1 will execute less tasks in parallel than is the case for a programmable processor 6.1. Consequently it is less important to apply interrupt selection techniques as illustrated in FIG. 6.

FIG. 8 shows a channel controller 8.1 in more detail. The channel controller 8.1 comprises a generic bus master slave unit 8.2, a register file 8.3 and a control unit 8.4.

The bus adapter 7.4 and the generic bus master slave unit 8.2 together couple the channel controller 8.1 to the bus. The bus adapter 7.4 provides an adaptation from a particular interconnection network, e.g. a PI-bus or an AHB-bus to a generic interface. The generic bus master slave unit 8.2 provides for an adaptation of the synchronization signals to said generic interface. In this way it is possible to support different channel controller types and different buses with a relatively low number of different components.

The register file 8.3 stores the synchronization information.

In case the device synchronization interface of a processor 7.1 issues the signal Claim in order to claim a number of writable or readable tokens in the buffer, the control unit 8.4 verifies whether this number is available by comparing the locally stored value of the remote counter remotec with its reservation counter localrsvc. The notation remotec signifies writec for an input channel and readc for an output channel. The notation localrsvc refers to readrsvc for an input channel and writersvc for an output channel.

If the verification is affirmative, the address of a token Token Address is returned. Otherwise, the upper boundary address of the buffer space reserved for the processor 7.1 could be returned. The signal Token Valid indicates if the claim for tokens was acknowledged, and the processor's synchronization interface can rise the signal Claim again. In this way a token address can be provided to the processor at each cycle. If the outcome of the first verification is negative, the channel controller 8.1 reads the remote counter indicated by the address remotecaddr and replaces the locally stored value remotec by the value stored at that address. The control unit 8.4 now again verifies whether the claimed number of tokens is available.

If the request fails, the channel controller 8.1 could either poll the remote counter regularly in a polling mode or wait for an interrupt by the processor with which it communicates in an interrupt mode. In the mean time it may proceed with another task. The variable inputchannel in the register indicates to the channel controller whether the present channel is an input or an output channel and which of these modes is selected for this channel.

After a successful claim the variable localrsvc is updated in conformance with the number of tokens that was claimed.

Instead of the variable remotec, the register file could comprise a variable indicating the number of available tokens calculated with the last verification.

In case that the processor 7.1 signals Release_req the local counter locale is updated in accordance with this request. This local counter localc is readc for an input channel and writec for an output channel. Optionally the signal Release_req may be kept high so that the processor 7.1 is allowed to release tokens at any time. However, this signal could be used to prevent flooding the controller when it is hardly able to access the bus.

Alternatively the synchronization process could be implemented in software by using a claim and a release function. By executing the claim function a processor claims a number of tokens for a particular channel and waits until the function returns with the token address. By executing the release function the processor releases a number of tokens for a particular channel. Separate functions could exist for claiming tokens for writing or tokens for reading. Likewise separate functions may be used for releasing.

It is remarked that the scope of protection of the invention is not restricted to the embodiments described herein. Neither is the scope of protection of the invention restricted by the reference numerals in the claims. The word ‘comprising’ does not exclude other parts than those mentioned in a claim. The word ‘a(n)’ preceding an element does not exclude a plurality of those elements. Means forming part of the invention may both be implemented in the form of dedicated hardware or in the form of a programmed general purpose processor. The invention resides in each new feature or combination of features.

1. A data processing apparatus comprising at least a first and a second processor, which processors are capable of communicating data to each other by exchanging tokens via a buffer according to a synchronization protocol, which protocol maintains synchronization information comprising at least a first and a second synchronization counter, which are readable by both processors, at least the first processor being capable of modifying the first counter, and at least the second processor being capable of modifying the second counter, the protocol comprising at least a first command which when issued by a processor results in a verification whether a requested number of tokens is available to said processor, and a second command which results in updating one of the synchronization counters to indicate that tokens are released for use by the other processor,
wherein at least one of the processors comprises a storage facility for locally storing an indication of the amount of tokens available to that processor, wherein issuing the first command results in a verification of the number of tokens available to said processor on the basis of said indication,
wherein a negative outcome of said verification results in updating of this indication on the basis of at least one of the synchronization counters,
wherein issuing the second command by a processor results in updating the indication in accordance with the number of tokens released to the other processor.

2. Data processing apparatus according to claim 1, wherein the indication initially indicate that no buffer space is available.

3. Data processing apparatus according to claim 1, being arranged for updating the indication on the basis of at least one of the synchronization counters, independent of the first command.

4. Data processing apparatus according to claim 1, wherein the first synchronization counter is indicative for an amount of tokens released by the first processor and the second synchronization counter is indicative for an amount of buffer space released by the second processor.

5. Data processing apparatus according to claim 1, wherein the first synchronization counter is indicative for an amount of tokens available to the first processor and the second synchronization counter is indicative for an amount of tokens available to the second processor.

6. Data processing apparatus according to claim 1, comprising one or more further second processors, wherein each of the second processors reads the data produced by the first processor.

7. Data processing apparatus according to claim 1, wherein at least one of the processors is a general purpose processor or an application specific programmable device executing a computer program.

8. Data processing apparatus, wherein at least one of the processors is a dedicated processor.

9. Method for operating a data processing apparatus comprising at least a first and a second processor, wherein the processors communicate data to each other by exchanging tokens via a buffer according to a synchronization protocol, which protocol maintains synchronization information comprising at least a first and a second synchronization counter, which are readable by both processors, at least the first processor being capable of modifying the first counter, and at least the second processor being capable of modifying the second counter, the protocol comprising at least a first command which when issued by a processor results in verifying whether a requested number of tokens is available to said processor and/or an ownership of the requested number of tokes, and a second command which results in updating one of the synchronization counters to indicate that tokens are released for use by the other processor,
wherein at least one of the processors comprises a storage facility for locally storing an indication of the amount of tokens available to that processor, wherein issuing the first command results in a verification of the number of tokens available to said processor on the basis of said indication,
wherein a negative outcome of said verification results in updating of this indication on the basis of at least one of the synchronization counters,
wherein issuing the second command by a processor results in updating the indication in accordance with the number of tokens released to the other processor.
